(19) United States
(12) Patent Application Publication
(10) Pub. No.: US 2010/0026098 A1
(43) Pub. Date: Feb. 4, 2010

(54) Power supply assembly

(76) Inventors: Filippo Marbach, Carabbia (CH); Vllaznim Xhiha, Lugano (CH); Jörg Kreiling, Herborn (DE)

Correspondence Address: Pauley Petersen & Erickson, 2800 West Higgins Road, Suite 365, Hoffman Estates, IL, 60169, US

(21) Appl. No.: 12/311,583

(22) PCT Filed: Oct. 23, 2007
(86) PCT No.: PCT/EP2007/009169

§ 371 Date: Apr. 3, 2009

(30) Foreign Application Priority Data
Oct. 23, 2006 (DE) 102006050289.2

(51) Int. Cl. H02J 7/00

(52) U.S. Cl. 307/66; 307/64

(57) ABSTRACT

A power supply assembly including a plurality of power supply modules which can be operated in parallel and are inserted or can be inserted into a common switch cupboard or rack or into a plurality of switch cupboards or racks, each power supply module having an inverter branch for continuously supplying electric power to a load at the output in a load branch. The power supply assembly also has a bypass assembly that ensures the power supply when power supply through the inverter branch fails or is insufficient. The reliability of the power supply is enhanced if each of the power supply modules has a bypass which is connected to the load branch, in parallel to the inverter branch. The bypass is separated from the load branch when the inverter path works properly and in the event of failure of an inverter branch, can be automatically connected by a control circuit to the load branch in order to maintain power supply.

### BACKGROUND OF THE INVENTION

1. Field of the Invention

This invention relates to a power supply assembly, having a plurality of power supply modules, which can be or are installed in one common, or in separate switchgear cabinets or racks and can be operated in parallel, each of which has an inverter branch for interruption-free electrical power supply of a load located in a load branch at the outlet, and having a bypass arrangement for assuring the power supply when this is not, or not sufficiently, provided from the inverter branch.

2. Discussion of Related Art

A power supply assembly of this type is taught by European Patent Reference EP 1 194 993 B1. Here, individual power supply modules can be operated in a suitable parallel manner by a common control arrangement in order to provide loads or consumers, which have relatively large power requirements, such as computer centers and control monitors, for example, with electrical current, even if the supply via the electrical network fails. In the event of a complete or partial failure of the electrical network supply, power is made available from a switched in storage battery unit. The goal is special control in connection with a master operation in which a replacement master can become functional. Another problem area relates to making an electrical power supply available when the inverter path of the power supply module itself does not operate correctly, or connected maintenance work has to be performed. In this case, the electrical power supply is continued via a bypass circuit. However, functional failures can occur.

A modularly-constructed, in particular a three-phase, interruption-free electrical power supply is also presented in “Markt & Technik”, [Market & Technology] No. 36, September 2000, at page 26.

### SUMMARY OF THE INVENTION

One object of this invention is to provide a power supply assembly of the type mentioned above but in which the dependability of supplying a connected load with electrical current is increased.

This object is attained by characteristics taught in this specification and in the claims. There, parallel with the inverter branch, the power supply modules each has a bypass which, in case of an error-free functioning of the inverter paths, is separated from the load branch, and in case of a malfunction of the inverter branch can be automatically connected with the load branch by a control circuit for maintaining the supply. In this case, the respective inverter branch, or all inverter branches, can be disconnected to assure the supply exclusively by one or several bypasses.

With the bypass respectively assigned to the inverter branch and advantageously located in the housing of the same power supply module, redundancy of the bypass arrangement with an advantageous control possibility, as well as monitoring possibility thereof, is obtained, for increased dependability of the power supply to the load.

Here, several advantageous embodiment possibilities include that the control circuit is designed so that, in case of a malfunction of a power supply module, it only switches through the bypass arranged in the same power supply module, or it is designed so that it monitors several power modules in regard to the appearance of an error in the inverter branch and, in case of a malfunction in a power supply module, a bypass in one or several other power supply modules can be switched through.

Monitoring and control of the power supply is aided because respectively, one electrical current measuring unit is arranged in the bypass, having a signal supplied to the control circuit for monitoring the electrical current in the bypass, and in case of a failure of the bypass a switching member can be actuated by the control circuit and/or an alarm regarding the failure can be triggered.

Exact individual monitoring and control options allow the control circuit to determine whether a short circuit exists in the bypass or, if voltage via the bypass is requested, an interruption exists.

Those steps add to dependable functioning, because in accordance with the switching member in the bypass is a contactor, which in case of a short circuit in the bypass is opened by the control circuit.

Also, those steps are advantageous for the operation of the bypass in accordance with a switching unit, which can be controlled by the control circuit, and is provided in the bypass.

Furthermore, those steps contribute to a dependable power supply of the load in accordance with which a rectifier arrangement is provided in the inverter path at the entry to the electrical supply network, and an inverted rectifier arrangement at the outlet. A storage battery unit is connected between the rectifier arrangement and the inverted rectifier arrangement, which can be charged via the rectifier arrangement and through which electrical power can be provided via the inverted rectifier arrangement.

The dependability of the power supply is also aided because a storage battery unit is assigned in a decentralized manner to each power supply module. Maintenance and the control function are also aided by these steps, because it is, for example, possible to replace an individual storage battery unit.

Function of the power supply assembly is improved if a direct voltage amplifying unit or booster is arranged between the storage battery unit and the connecting point between the rectifier arrangement and the inverted rectifier arrangement, so that an optimal adaptation and operation of the inverted rectifier is achieved.

Those steps also contribute to dependable functioning and control, and separate networks are assigned to the bypasses and the inverter branches.

Maintenance work is aided if the inlets and/or outlets of the power supply modules are connected to the electrical supply network and/or the load branch by individually assigned and/or a common, manually operable electrical arrangements for switching on and off. If individual arrangements for switching on and off exist for the power supply modules, it is possible to maintain the operation via the remaining power supply modules, particularly if the arrangement for switching on and off is located at the inlet of the respective module.

Control, or respectively operation, are aided if there is a central disconnect switch which is normally open, by which the electrical supply network can be directly connected with the load branch.

An advantageous design for control and monitoring includes control circuits are assigned to the respective power supply modules and are subordinated to a common control arrangement. An operation through the inverter branches or bypass takes place on the basis of a majority decision made by the control arrangement. In this case, the respective control circuits can be arranged in the housings of the individual power supply modules, while the control arrangement can be arranged in a separate housing and communicates with the control circuits via control lines, in particular a bus connection, or in a wireless manner. A direct, wire-transmitted, or a wireless communication between the control circuits is possible.

Also, those steps are advantageous for the design and operation in accordance with which the power supply modules are designed as push-in units which, when pushed into a receptacle provided in the switchgear cabinet or the rack, can be brought into electrical contact simultaneously with the push-in movement.

### BRIEF DESCRIPTION OF THE DRAWINGS

This invention is explained in greater detail in view of exemplary embodiments, making reference to the drawings, wherein:

FIG. 1 shows a circuit design of a power supply assembly, having two power supply modules, in a schematic plan view;

FIG. 2A shows a diagram of a control concept in the event of a short circuit in the bypass arrangement; and

FIG. 2B shows a diagram of a control concept with the control arrangement opened.

### DETAILED DESCRIPTION OF THE INVENTION

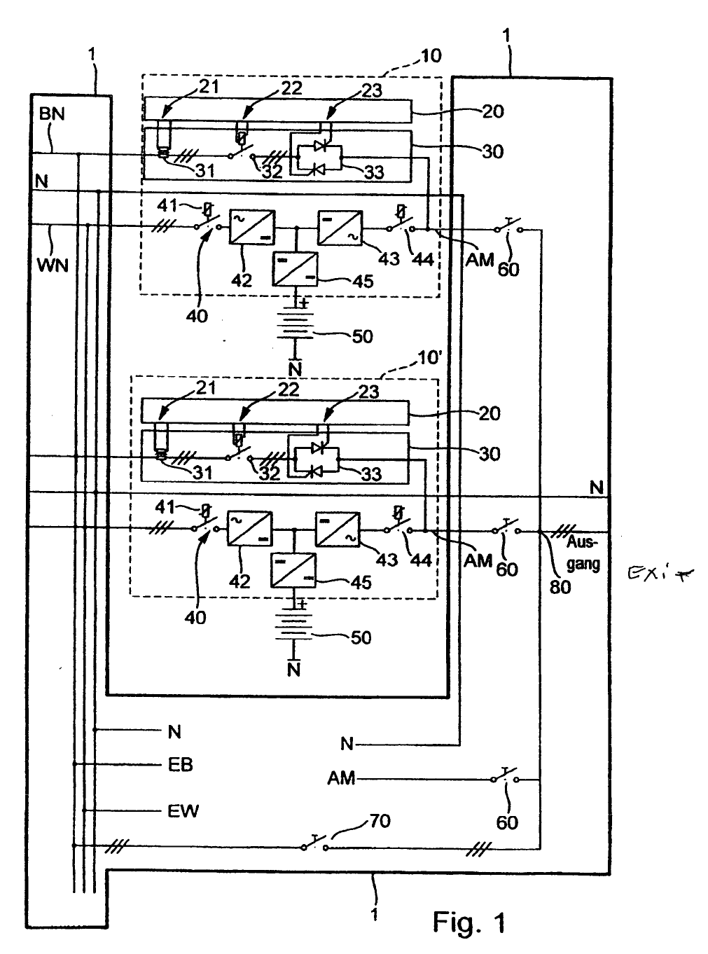

FIG. 1 shows a switchgear cabinet 1 or rack, having two power supply modules 10, 10′, for example, which are inserted in receptacles thus provided and are designed as push-in modules, which can be inserted on lateral rails, for example, and have respective housings matched to the receptacles and provided with sliding sections. Plugs or sockets are arranged on the back of the housings, which are exactly matched to complementary sockets or plugs in the interior of the receptacle and which, in the completely inserted state, engage these in an electrically conducting manner. Further plug connections can be arranged on the front of the housings. It is also possible to arrange further power supply modules in appropriate receptacles of the switchgear cabinet 1 or racks, or also of additional switchgear cabinets or racks, which are included in the power supply assembly. On the inlet side, the power supply modules 10, 10′ are connected to an electrical supply network with a neutral conductor N, bypass inlet EB and inverter branch inlet EW, for which purpose an inverter network WN and a bypass network BN, which is separate from the former, are advantageously, but not necessarily, provided. On the outlet side, the power supply modules are connected via respective disconnect switches 60 with a load branch 80, through which the load to be supplied, or consumers which constitute it, are connected.

Each of the individual power supply modules 10, 10′ has, advantageously in the same housing, an inverter branch 40 with, following each other in sequence from the inlet to the outlet, an electrically operable switching member 41, a rectifier arrangement 42, an inverted rectifier arrangement 43, and a further electrically operable switching member 44, all of which are arranged inside the housing. It is possible by the switching members 41 to operate or shut off the inverter branches 40 in a suitable manner as needed by a control arrangement. A d.c. voltage amplification unit 45 or booster is also advantageously connected inside the housing between the rectifier arrangement 42 and the inverted rectifier arrangement 43, whose other outlet is connected with a storage battery unit 50 arranged outside the housing and assigned to the respective power supply module 10, or 10′, in order to assure the required current supply to the consumers in case of an at least partial failure of the electrical supply network. With the d.c. voltage amplification unit 45 a match is provided between the battery voltage of the rechargeable storage battery unit 50 and the d.c. voltage inlet of the inverted rectifier for operation at an optimal degree of efficiency and can make available at its outlet a supply voltage which is stabilized in regard to amplitude and frequency. In this case, the battery or rechargeable battery units 50 of various power supply modules 10, 10′ can be used as decentralized redundant batteries and, by the control arrangement, can be included in a suitable manner, if desired variably, for supplying power. In case it fails or is exchanged, it is also possible to use the storage battery unit 50 of a power supply module 10 for another power supply module 10′ or, in case of insufficient capacity, to provide the combined use of the storage battery units 50 with the aid of the control arrangement.

Inside of the housing, a bypass 30 is respectively assigned to each of the inverter branches 40 of the power supply modules 10, 10′, which has, viewed from the inlet to the outlet, an electrical current measuring unit 31, a contactor 32 and a switching unit 33, preferably with a thyristor arrangement. On the outlet side, the bypass 30 is connected inside the housing to the outlet behind the further switching member 44 of the inverter branch 40.

The power supply modules 10, 10′ also have a control circuit 20, advantageously inside their housing, by which, inter alia, the components of the bypass 30 can be monitored, or respectively controlled, namely the electrical current measuring unit 31 for detecting the bypass current by a bypass current measuring arrangement 21, the contactor 32 for actuating it via a contactor triggering device 22, and the switching unit 33 for actuation by an appropriate triggering device, in particular a thyristor triggering device 23. The control circuits 20 of the individual power supply modules 10, 10′ can exchange information between each other via control lines, for example a bus connection, or in a wireless manner, or indirectly through a higher order control device. With the control and monitoring laid out this way, it is possible to advantageously monitor and control the consumers, which are connected by redundant bypasses for assuring the power supply, wherein it is possible to make different assignments, for example if an error in the bypass 30 is detected by the switching control arrangement 20.

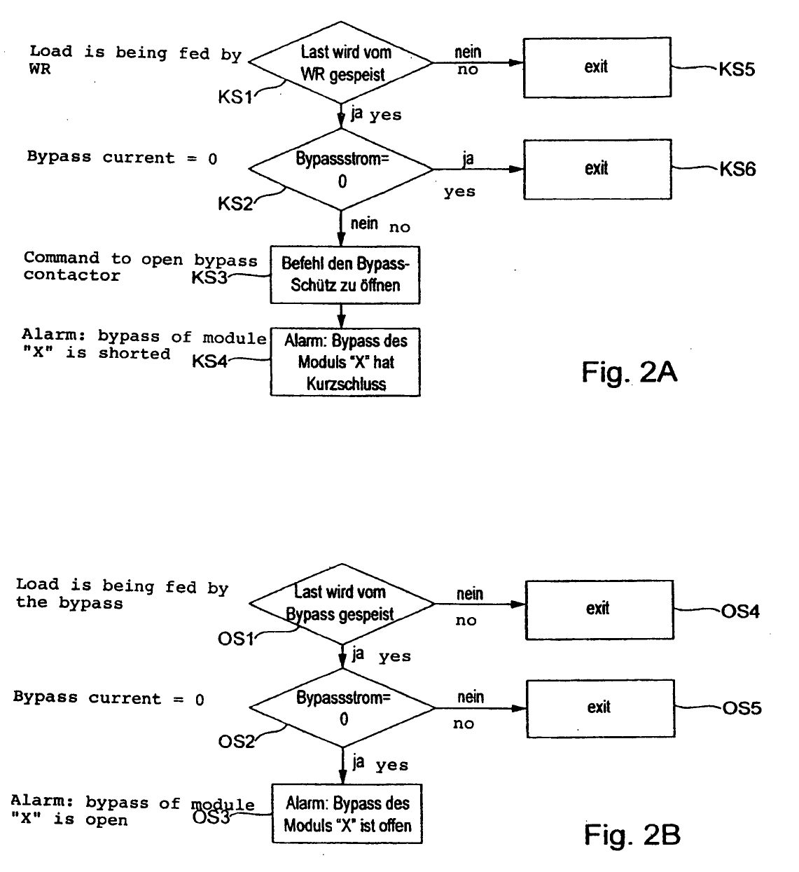

With respective flow diagrams, FIGS. 2A and 2B show different control processes in connection with two different events, namely for one in case of a short circuit in the bypass arrangement, and also with an opened bypass arrangement.

Here, in case of an event of a short circuit in the bypass arrangement, the logic device for the control of the redundant bypass initially makes an inquiry in a step KS1 as to whether the load is fed by the inverted rectifier arrangement 43. If not, then the control program continues in a step KS5 to the exit. If the load is supplied by the inverted rectifier arrangement 43, a check is made whether the respective bypass current is zero. If this is the case, the program proceeds in a step KS6 to the exit. If during the inquiry in step KS2 the bypass current is not zero, in a step KS3 the control circuit 20 issues the command via the contactor triggering device 22 for opening the bypass contactor 32, and furthermore, in a step KS4, for triggering an alarm, optically and/or acoustically, that a short circuit exists in the respective bypass.

In accordance with FIG. 2B, in case of the event of a bypass arrangement opened, the control process makes an inquiry in a step OS1 as to whether the load is fed by the respective bypass 30 or whether such a request exists. If not, then the program continues to the exit in a step OS4. If the load is fed by the bypass, in a further step OS2 a check is made whether the bypass current is zero. If not, then the program continues to the exit in a step OS5. If the bypass current is zero, triggering of an acoustic and/or optical alarm, the bypass of the respective power module is open, and takes place in a step OS3.

Thus, the power supply by the redundant bypass provides advantageous layout options for the logical control device, by which it is possible to substantially increase the dependability of the power supply. The decentralized batteries, or battery units 50 substantially contribute to the dependability of the power supply.

For maintenance work on individual modules, it is possible to actuate the individually assigned disconnect switches. Complementary or alternatively, it is possible to close a provided central disconnect switch 70 and to assure the power supply with it.

1. A power supply arrangement, having a plurality of power supply modules (10, 10′) installable in one common or in separate switchgear cabinets (1) or racks and operable in parallel, each of which has an inverter path (40) for and interruption-free electrical power supply of a load located in a load branch (80) at an outlet, and having a bypass arrangement for assuring a power supply when not or not sufficiently provided from the inverter branch, the power supply arrangement comprising:
parallel with the inverter path (40) the power supply modules (10, 10′) each having a bypass (30) which, in case of an error-free functioning of the inverter paths (40), connected with the load branch (80) and which, in case of a malfunction of an inverter path (40), can be automatically connected with the load branch by a control circuit (20) for maintaining the supply.

2. The power supply arrangement in accordance with claim 1, wherein the control circuit (20) is embodied so that, in case of a malfunction of a power supply module (10, 10′) the control circuit (20) only switches through the bypass (30) arranged in the same power supply module (10, 10′), or is designed to monitor several of the power modules (10, 10′) for an error in the inverter branch (40) and, in case of the malfunction in the power supply module (10), a bypass (30) in one or several other of the power supply modules (10) can be switched through.

3. The power supply arrangement in accordance with claim 2, wherein respectively one current measuring unit (31) is arranged in the bypass (30) with a signal supplied to the control circuit (20) for monitoring the current, and in case of a failure of the bypass (30) a switching member (32) is actuated by the control circuit (20), and/or an alarm regarding the failure can be triggered.

4. The power supply arrangement in accordance with claim 3, wherein the control circuit (21) can determine whether a short circuit exists in the bypass (30) or, if a voltage via the bypass is requested, an interruption exists.

5. The power supply arrangement in accordance with claim 4, wherein the switching member (32) in the bypass (30) is a contactor which in case of a short circuit is opened by the control circuit (20).

6. The power supply arrangement in accordance with claim 5, wherein a switching unit (33), which is controllable by the control circuit (21), is in the bypass (30).

7. The power supply arrangement in accordance with claim 6, wherein a rectifier arrangement (42) is in the inverter path (40) at an entry to the electrical supply network, and an inverted rectifier arrangement (43) at an outlet, and a storage battery unit (50) is connected between the rectifier arrangement (42) and the inverted rectifier arrangement (43), which can be charged via the rectifier arrangement (42) and through which electrical power can be provided via the inverted rectifier arrangement (43).

8. The power supply arrangement in accordance with claim 7, wherein the storage battery unit (50) is assigned in a decentralized manner to each of the power supply modules (10, 10′).

9. The power supply arrangement in accordance with claim 8, wherein a direct voltage amplifying unit (45) is between the storage battery unit (50) and the connecting point between the rectifier arrangement (42) and the inverted rectifier arrangement (43).

10. The power supply arrangement in accordance with claim 9, wherein separate networks (BN, WN) are assigned to the bypasses (30) and to the inverter paths (40).

11. The power supply arrangement in accordance with claim 10, wherein the inlets and/or the outlets of the power supply modules (10, 10′) are connected to the electrical supply network and/or the load branch (80) by individually assigned and/or a common manually operable electrical arrangements for switching on and off.

12. The power supply arrangement in accordance with claim 11, wherein a central disconnect switch (70) which is normally open directly connects the electrical supply network with the load branch (80).

13. The power supply arrangement in accordance with claim 12, wherein the control circuits (20) are assigned to the respective power supply modules (10, 10′) and are subordinated to a common control arrangement, and an operation through the inverter paths (40) or the bypass (30) takes place on a basis of a majority decision made by the control arrangement.

14. The power supply arrangement in accordance with claim 13, wherein the power supply modules (10, 10′) are push-in units which, when pushed into a receptacle provided in the switchgear cabinet or the rack, can be brought into electrical contact simultaneously with the push-in movement.

15. The power supply arrangement in accordance with claim 1, wherein respectively one current measuring unit (31) is arranged in the bypass (30) with a signal supplied to the control circuit (20) for monitoring the current, and in case of a failure of the bypass (30) a switching member (32) is actuated by the control circuit (20), and/or an alarm regarding the failure can be triggered.

16. The power supply arrangement in accordance with claim 1, wherein the control circuit (21) can determine whether a short circuit exists in the bypass (30) or, if a voltage via the bypass is requested, an interruption exists.

17. The power supply arrangement in accordance with claim 3, wherein the switching member (32) in the bypass (30) is a contactor which in case of a short circuit is opened by the control circuit (20).

18. The power supply arrangement in accordance with claim 1, wherein a switching unit (33), which is controllable by the control circuit (21), is in the bypass (30).

19. The power supply arrangement in accordance with claim 1, wherein a rectifier arrangement (42) is in the inverter path (40) at an entry to the electrical supply network, and an inverted rectifier arrangement (43) at an outlet, and a storage battery unit (50) is connected between the rectifier arrangement (42) and the inverted rectifier arrangement (43), which can be charged via the rectifier arrangement (42) and through which electrical power can be provided via the inverted rectifier arrangement (43).

20. The power supply arrangement in accordance with claim 7, wherein a direct voltage amplifying unit (45) is between the storage battery unit (50) and the connecting point between the rectifier arrangement (42) and the inverted rectifier arrangement (43).

21. The power supply arrangement in accordance with claim 1, wherein separate networks (BN, WN) are assigned to the bypasses (30) and to the inverter paths (40).

22. The power supply arrangement in accordance with claim 1, wherein the inlets and/or the outlets of the power supply modules (10, 10′) are connected to the electrical supply network and/or the load branch (80) by individually assigned and/or a common manually operable electrical arrangements for switching on and off.

23. The power supply arrangement in accordance with claim 1, wherein a central disconnect switch (70) which is normally open directly connects the electrical supply network with the load branch (80).

24. The power supply arrangement in accordance with claim 1, wherein the control circuits (20) are assigned to the respective power supply modules (10, 10′) and are subordinated to a common control arrangement, and an operation through the inverter paths (40) or the bypass (30) takes place on a basis of a majority decision made by the control arrangement.

25. The power supply arrangement in accordance with claim 1, wherein the power supply modules (10, 10′) are push-in units which, when pushed into a receptacle provided in the switchgear cabinet or the rack, can be brought into electrical contact simultaneously with the push-in movement.
